(19) United States
(12) Patent Application Publication
(10) Pub. No.: US 2006/0061001 A1
(43) Pub. Date: Mar. 23, 2006

(54) Mold for and method of making an integral skin foam part

(76) Inventors: Kenneth Wamshuis, Adrian, MI (US); Felipe R. Terrones, Adrian, MI (US); Victor Gandara, Adrian, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 10/945,063

(22) Filed: Sep. 20, 2004

(51) Int. Cl. B29C 44/00

(52) U.S. Cl. 264/45.5; 264/45.7; 425/450.1

(57) ABSTRACT

A method for making an integral skin foam object in a mold mounted on a mold carrier is disclosed, comprising the steps of injecting a mixture of a polyol and an isocyanate into the mold, closing mold halves together, rotating the mold carrier about 80 to 110 degrees and allowing the mixture to react to form a polyurethane foam which fills the mold cavity. Preferably the mold clamping pressures are 300-600 psi.

### FIELD OF THE INVENTION

This invention relates to improvements in integral skin foam objects, and more particularly to improvements in methods of making integral skin foam objects.

### BACKGROUND OF THE INVENTION

Integral skin foam objects are used in many applications, including steering wheels, instrument panels, console box lids and glove box lids, armrests and headrests, etc. For example, headrests have been used in motor vehicles for many years, and provide both a convenient place to rest an operator's head and also provide protection in the event of sudden changes in acceleration of the motor vehicle. Headrests also often are adjustably mounted to a seat to provide comfort adjustment. Generally, such headrests include cloth covered headrests and integral skin foam headrests. With cloth covered headrests, a foam or cushion like interior is shrouded by a cloth. Integral skin foam headrests have an exterior integral skin region with a low degree of foaming (often with a urethane paint applied to the molded part) and an interior region having a high degree of foaming. The foam material is typically polyurethane foam formed from a reaction of a polyol and an isocyanate. Known integral skin foam parts have had problems with exterior surface irregularities. These were manageable for part designs where part of the exterior surface was hidden from view. However, for parts where essentially the entire exterior surface is a “show surface” (visible to the user of the part), such surface irregularities prevented widespread use of integral skin foam technology without a cover. Therefore, it would be highly desirable to have an improved, low cost, method of making integral skin foam objects with improved show surface characteristics.

### SUMMARY OF THE INVENTION

In accordance with a first aspect, a method for making an integral skin foam object in a mold mounted on a mold carrier is disclosed, comprising the steps of injecting a mixture of a polyol and an isocyanate into the mold, closing mold halves together, rotating the mold carrier about 80 to 110 degrees and allowing the mixture to react to form a polyurethane foam which fills the mold cavity. In accordance with another aspect, the mold clamping pressures are 300-600 psi, and the mold has upper and lower seals having widths of only about 0.25″ to 0.5″.

From the foregoing disclosure and the following more detailed description of various preferred embodiments it will be apparent to those skilled in the art that the present invention provides a significant advance in the technology of integral skin foam parts. Particularly significant in this regard is the potential the invention affords for providing a method of making a high quality integral skin foam part with an aesthetically attractive exterior or show surface. Additional features and advantages of various preferred embodiments will be better understood in view of the detailed description provided below.

### BRIEF DESCRIPTION OF THE DRAWINGS

FIG. 1 is a perspective view of a mold having a top half and a bottom half, and a mold carrier for making an integral skin foam part, in accordance with a preferred embodiment, showing the mold open and the mold halves positioned at an offset angle with respect to the mold carrier.

FIG. 2 is a side view of the mold and mold carrier of FIG. 1, showing the mold closed and lying in a down position generally horizontal with respect to the floor.

FIG. 3 is a side view of the mold and mold carrier of FIG. 1, showing the mold closed and rotated to an upright position.

FIG. 4 is an exploded perspective view of the bottom half of the mold and mold carrier of FIG. 1, showing air bags which, when pressurized, help increase the seal pressure on the mold halves.

FIG. 5 is an isolated perspective view of the mold halves of FIG. 1, showing upper and lower seals extending circumferentially around the top half and bottom half of the mold, respectively.

FIG. 6 is a perspective view of an integral skin foam part with a pin inserted to allow ambient air to enter the part.

It should be understood that the appended drawings are not necessarily to scale, presenting a somewhat simplified representation of various preferred features illustrative of the basic principles of the invention. The specific design features of the mold and method of making an integral skin foam part disclosed here, including, for example, the specific dimensions of the mold cavity will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the mold and method of making an integral skin foam part disclosed here. The following detailed discussion of various alternative and preferred features and embodiments will illustrate the general principles of the invention with reference to a headrest suitable for use in automotive applications. Other embodiments suitable for other applications will be apparent to those skilled in the art given the benefit of this disclosure.

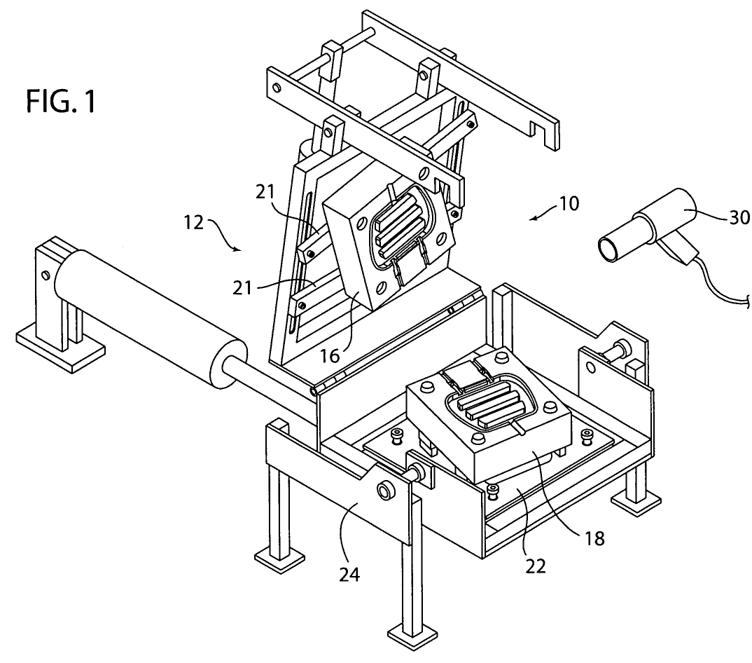

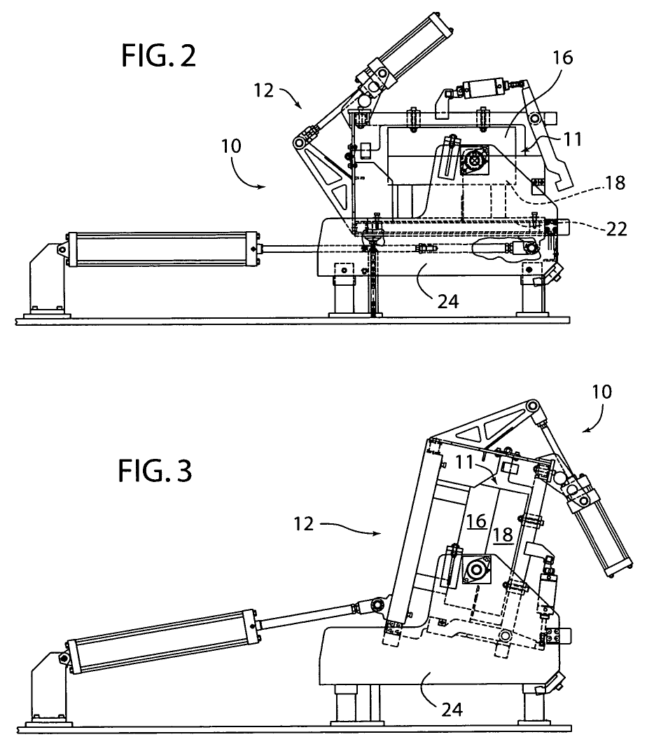

Referring now to the drawings, FIG. 1 shows a mold assembly 10 comprising a mold 11 mounted on a mold carrier 12, upper half of mold 16, and lower half of mold 18. The halves of the mold 11 can be closed together and cooperate to define a mold cavity which corresponds to the shape of the object to be molded. In the preferred embodiment shown in the drawings, the object is a headrest. The mold carrier is mounted on a frame 24 aligned generally parallel to a floor. The mold carrier 12 is pivotable about a horizontal (with respect to the floor) axis, and the mold halves 16, 18 travel with the mold carrier. Preferably the mold halves are adjustably attached to the carrier; with upper half 16 attached at support beams 21 and lower half 18 attached at support plate 22. In accordance with a highly advantageous feature, the mold halves may be aligned at an angle offset from the mold carrier. That is, the mold carrier may be generally rectangular shaped and the mold may be generally rectangular shaped, and the rectangular shapes are offset from one another. As shown in the example in FIG. 1, the mold halves 16, 18 are offset by about 30-55 degrees, most preferably about 40-50 degrees with respect to the carrier 12. This allows a preselected portion of the mold to be aligned generally vertically when the mold halves are pivoted from the down position (shown in FIG. 2) to the upright position (shown in FIG. 3), as described in further detail below.

Broadly, manufacture of an integral skin foam object or part as disclosed herein comprises preferably spraying or otherwise applying a mold release to the mold halves to help the part separate from the mold halves, and then spraying or otherwise applying each of the mold halves 16, 18 with a urethane paint. Once these steps are completed, a reactive two component mixture is introduced into the mold which, under mild heating, foams to fill the mold cavity. Generally greater foaming occurs in the center of the part, and the paint forms an integral skin to produce an aesthetically appealing show surface. A polyurethane foam part 14 is formed by reaction of two components: a polyol and an isocyanate introduced together into the mold. In the preferred embodiment shown in the Figs., the part 14 is an automotive headrest having a mounting insert 34, which during assembly is laid into proper alignment in the bottom mold half 18, typically after application of paint but prior to introduction of the two component mixture. The part 14 has a parting line 99 corresponding to where the mold halves meet. A heat gun 30 (FIG. 1) may be used to blow hot air over the two component mixture in the open mold to break gas bubbles formed after the initial application of the mixture. It has been found that use of such a heat gun helps reduce show surface irregularities on the finished part. Suitable mold releases, urethane paints and two component polyol/isocyanate mixtures will be readily apparent to those skilled in the art given the benefit of this disclosure.

In accordance with another highly advantageous feature, the mold halves are closed together in a down position shown in FIG. 2, and then the mold is rotated by the mold carrier 12 about 80 to 110 degrees, most preferably about 90 degrees with respect to the frame 24, to an upright position shown in FIG. 3. The two component mixture reacts quickly with gentle heating and expands to fill the mold cavity. Preferably when the two mold halves close together, a gas passageway is formed, allowing the reaction to take place at ambient pressure and allowing gas to escape. The air passageway is shown in FIG. 5 as the volume 36 between the mounting insert 34 and the mold halves, and a shim vent 40. Flash or extra material from the foaming two component mixture will flow through the air passageway, and can be trimmed in a secondary operation.

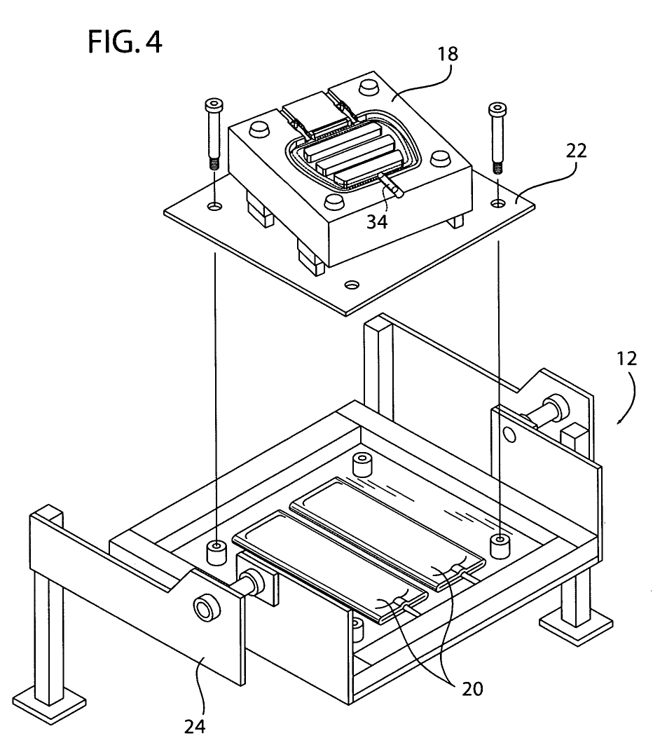

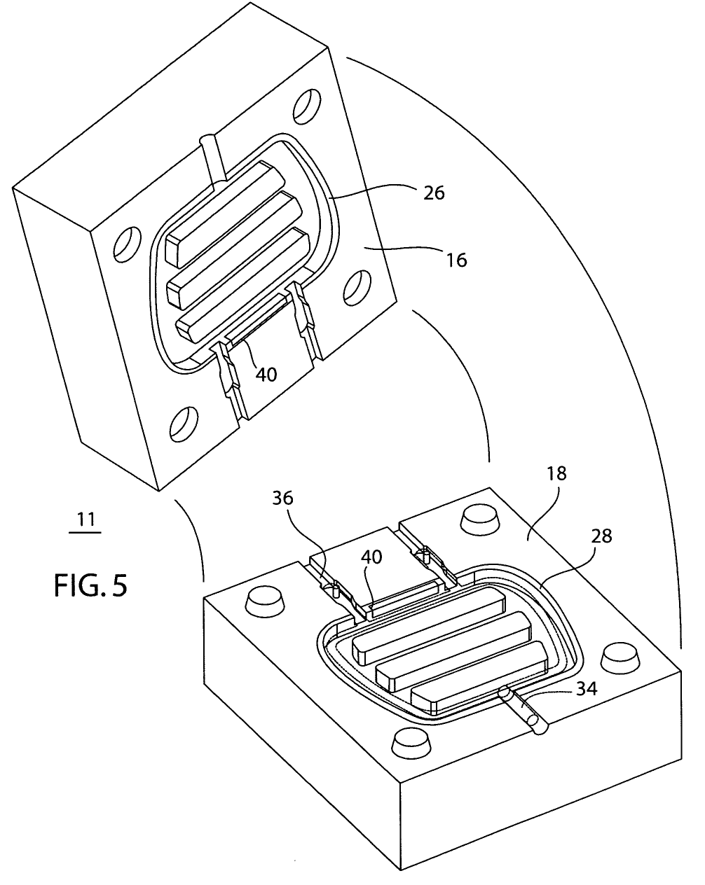

The mold halves 16, 18 have corresponding seals 26, 28 extending circumferentially around the mold cavity, as seen in FIGS. 1 and 5. Known molds for polyurethane typically had low clamping pressures, on the order of 100-150 psi, and had problems with excessive flash. Therefore seals for polyurethane molds were 0.75″ to 1.5″ wide. In accordance with a highly advantageous feature, the clamping pressures are increased to 300-600 psi and the seal width is 0.25 to 0.5 inches, most preferably about 0.375″. Air bags 20 are positioned under the plate 22. The plate is seen in FIG. 4 to be somewhat vertically adjustable. When the mold is closed and the air bags 20 are inflated, the bags place pressure on the plate 22, forcing the plate upward, which in turn squeezes the lower seal 28 against the upper seal 26, increasing clamping pressure, decreasing flash and allowing the seal width to be smaller.

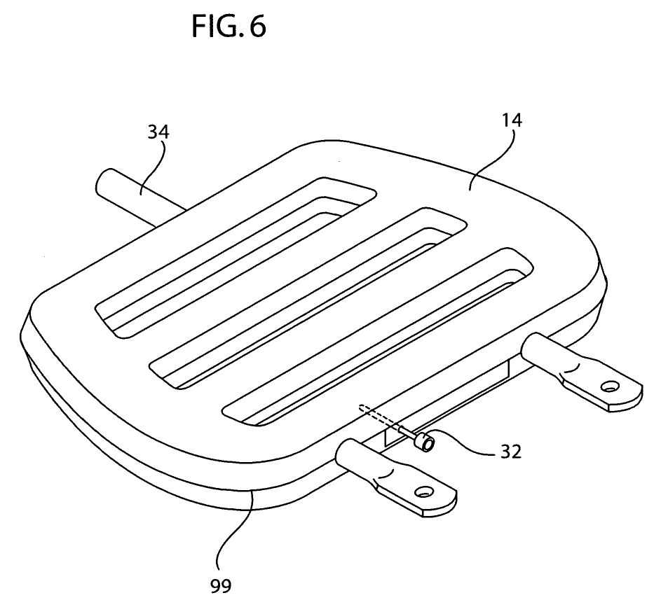

When the polyurethane foam object is removed from the mold, it is still warm, and the gas that creates the internal foam bubbles is naturally warm as well. To help equalize the pressure and reduce show surface irregularities, it has been found that in certain preferred embodiments a pressure equalization valve 32 may be inserted into the object, preferably at the area of the object formed adjacent the shim vent as seen in FIG. 6.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of making an integral skin foam object in a mold mounted on a mold carrier, the mold having an upper mold half and a lower mold half, comprising, in combination, the steps of:
injecting a mixture of a polyol and an isocyanate into the mold; closing the mold halves together;
rotating the mold carrier about 80 to 110 degrees; and
allowing the mixture to react to form a polyurethane foam which fills the mold cavity.

2. The method of claim 1 further comprising a frame, wherein the mold carrier is pivotably mounted on the frame.

3. The method of claim 1 further comprising the step of
applying paint to the upper half and the bottom half of the mold prior to injecting the mixture of polyol and isocyanate.

4. The method of claim 3 further comprising the step of
inserting a headrest frame into the mold after applying the paint.

5. The method of claim 1 wherein the upper half and lower half of the mold cooperate to define a gas passageway when the mold is closed, allowing the mixture to fill the mold at ambient pressure.

6. The method of claim 5 wherein once the mold halves are closed together the mold is in a down position, and after the mold carrier has rotated the mold is in an upright position.

7. The method of claim 6 wherein the gas passageway is positioned near the top of the mold when the mold is in the upright position.

8. The method of claim 1 wherein the mold halves are positioned about 35-55 degrees offset with respect to the carrier.

9. The method of claim 1 further comprising blowing hot air over the mixture prior to closing the mold halves together.

10. The method of claim 1 further comprising
removing the object from the mold; and
inserting a pressure equalization valve into the object.

11. The method of claim 1 further comprising
prior to closing the mold, blowing hot air over the mixture.

12. A mold assembly for making an integral skin foam object, comprising, in combination:
an upper half of the mold and a lower half of the mold which close together to form a mold cavity;
a upper mold seal circumferentially extending around the upper half of the mold and a lower mold seal circumferentially extending around the lower half;
wherein the mold seals engage one another when the mold is closed and define an edge of the mold cavity; and
a clamping pressure of about 300-600 psi is applied to the mold seals.

13. The mold assembly of claim 12 wherein the upper seal and lower seal are each about 0.25 to 0.5 inches thick.

14. The mold assembly of claim 12 further comprising a mold carrier having a plate;
wherein the lower half of the mold is mounted on the plate and air bags are positioned under the plate which, when inflated, engage the plate and increase clamping pressure on the mold seals.
